(19) United States
(12) Patent Application Publication
(10) Pub. No.: US 2010/0126115 A1
(43) Pub. Date: May 27, 2010

(54) Wind Turbine Tower Monitoring Device

(75) Inventors: Khoon Peng Lim, Singapore (SG); Lie Ling Zhang, Singapore (SG); Pey Yen Siew, Singapore (SG); Xiao Qian Li, Singapore (SG)

Correspondence Address: COHEN, PONTANI, LIEBERMAN & PAVANE LLP, 551 FIFTH AVENUE, SUITE 1210, NEW YORK, NY, 10176, US

(73) Assignee: Vesta Wind Systems A/S, Randers (DK)

(21) Appl. No.: 12/340,091

(22) Filed: Dec. 19, 2008

(30) Foreign Application Priority Data
Nov. 21, 2008 (GB) 0821262.3

(51) Int. Cl. G01B 7/16; E04H 12/00

(52) U.S. Cl. 52/848; 73/856

(57) ABSTRACT

A wind turbine installation monitoring device, for detecting relative movement between two adjacent components of a wind turbine installation is provided. The device comprises a deformable member together with a securing device. The securing device is configured to enable the device to be connectable to a wind turbine installation, in use. The deformable member is located across an interface between the adjacent components of a wind turbine installation. Further, a detection device is provided and configured to detect deflection of the deformable member and thereby to detect relative movement between the two components.

### BACKGROUND OF THE INVENTION

1. Field of the Invention

The present invention relates to the field of wind turbine towers and, in particular to monitoring the loading to which such towers, or their sub-components, are exposed in normal operation.

2. Description of Background of Art

A wind turbine tower or pylon typically supports a nacelle to which are attached one or more turbine blades. The, or each, turbine blade rotates relative to a longitudinal axis of the nacelle. Due to this rotational movement, the loading experienced by the nacelle and the turbine tower are dynamic in nature. As the turbine blades rotate at different rates, depending on the strength of the wind at any given time, the magnitude of the loading is also a dynamic phenomenon. Consequently, whenever the wind turbine is rotating the entire wind turbine tower experiences fluctuating loads.

Wind turbine blades are typically in excess of 50 m each and therefore the wind turbine tower supporting these blades may be in excess of 100 m tall and represents a significant structure. Such towers are, generally, roughly cylindrical often having a slight taper and, therefore, comprise a plurality of frusto-conical sections stacked one upon another in series. Flanges are provided at each end of each section and corresponding flanges are bolted to one another. The flanges and bolts are also exposed to the aforementioned dynamic loading exerted by the turbine blades and transmitted down the wind turbine tower.

The dynamic loading may result in fatigue of the bolts and, in the extreme, creep thereof may occur. In order to avoid failure of the bolts, and subsequent potential damage to or even collapse of the tower, frequent inspection, maintenance and/or replacement of the bolts must be carried out. Such a maintenance schedule is onerous and, in particular, time consuming leading to reduced power production time.

It is desirable to reduce the burden of the maintenance schedule whilst maintaining the safety and integrity of the wind turbine tower such that power production can be enhanced.

### SUMMARY OF THE INVENTION

According to the present invention there is provided a wind turbine installation monitoring device, for detecting relative movement between two adjacent components of a wind turbine installation, the device comprising:

a deformable member;

securing means, configured to enable the device to be connectable to a wind turbine installation, in use, such that the deformable member is located across an interface between the adjacent components of the wind turbine installation; and

detection means configured to detect deformation of the deformable member and thereby to detect relative movement between the two components.

By providing a measuring device that extends across the interface of adjacent components of the wind turbine installation, relative movement of each component with respect to the other component can be detected. This movement directly relates to the local loading experienced by a bolt used to secure the components to one another. Consequently, the loading exerted on the, or each, bolt over time can be monitored and a history of the strains experienced thereby can be established. In this way, an assessment of the current status of the bolt can be more accurately predicted and any unexpected failure of the, or each, bolt may be detected.

The adjacent components of the wind turbine installation may each be provided with flanges and the device may be configured to be located across an interface between two flanges and secured to respective flanges in order to detect relative movement between the flanges. The components may be sections of a wind turbine tower of the wind turbine installation.

According to a second aspect of the present invention there is provided a wind turbine tower monitoring device, for detecting relative movement between flanges of adjacent sections of the tower, the device comprising:

a deformable member;

securing means, configured to enable the device to be connectable to a wind turbine tower, in use, such that the deformable member is located across an interface between adjacent flanges of the wind turbine tower; and

detection means configured to detect deformation of the deformable member and thereby to detect relative movement between the two flanges.

By providing a monitoring device that is arranged to be connectable across an interface of adjacent flanges, local relative movement therebetween can be detected. Bolts securing one section of the wind turbine tower to an adjacent section are generally located through such flanges and, hence, any relative movement between the flanges is intimately related to the loading experienced by bolts connecting the two flanges together. Consequently, an accurate history of the loading experienced by the bolts can be ascertained.

The securing means may comprise clamping means, magnetic means and/or bonding means. Preferably, the securing means is non-invasive so that the integrity of the structure to which the device is secured is not impaired.

The detection means may comprise a sensor, for example a strain gauge or an optical sensor. Alternatively, the detection means may comprise a limit switch and/or a contact switch. The detection means may be connected to a surface of the deformable member. The deformable member may comprise a hinge.

The detection means may comprise means for transmitting a signal, indicative of a parameter associated with the detected relative movement, to analysing and/or storage means. The transmitting means may comprise a radio-frequency identification (RFID) element. Determining means may be provided for receiving a signal from the measurement means and determining an extent of the relative movement and, therefore, status of a bolt connecting one section to the other, in use.

The securing means may be non-invasive such that the wind turbine tower, to which the device is connected in use, is not required to be reconfigured upon installation thereof.

It is particularly advantageous to use a securing means that is non-invasive, in other words, no reconfiguration of the tower need take place in order to effect installation of the device. In particular, speed of installation or replacement of the device is consequently enhanced and any user induced damage is inhibited. Furthermore, interference with any mechanical fastening members is avoided and the strength of the tower/flange and the integrity of the structure are retained. According to a third aspect, the present invention provides a wind turbine tower comprising:

a first substantially cylindrical section;

a second substantially cylindrical section, configured to be assembled adjacent to the first section, each of the first and second sections having a flange formed thereon, the flanges being configured to be located adjacent one another upon assembly of the tower, the sections being secured to one another with one or more bolts each bolt being located through cooperating holes formed in each respective flange; and

a monitoring device, of the aforementioned type, located across an interface between the flanges and connected thereto enabling any relative movement between the flanges to be detected.

The monitoring device may be installed in proximity to a bolt. Such a proximate monitoring location enables an accurate assessment of the loads to which the bolt is exposed to be achieved.

According to a fourth aspect, the present invention provides, a method for determining the status of a bolt installed between two components of a wind turbine installation, the method comprising the steps of:

monitoring load experienced by the bolt over time;

collating a time dependent loading characteristic for the bolt;

assessing a status of the bolt; and

raising an alarm if the assessing step indicates a failure of the bolt.

By providing a method for determining the status of a bolt in this way, an accurate representation of the loading to which the bolt is exposed can be achieved. Thus the bolt need only be replaced if it is approaching a predetermined fatigue limit. Alternatively, it may be determined that the bolt is experiencing failure such as creep or even fracture in an unexpected manner at an unpredicted time. Under such circumstances the bolt may be replaced at the soonest opportunity and further potential damage to the wind turbine tower can be inhibited.

The assessing step may determine a current status of the bolt and/or it may determine a predicted future status of the bolt.

The monitoring step may comprise detecting a parameter indicative of relative displacement of two flanges through which the bolt is connected together and sending a signal indicative of the detected parameter to monitoring means.

The assessing step may comprise comparing the loading characteristic to a threshold characteristic and an alarm may be raised if the threshold characteristic is exceeded.

### BRIEF DESCRIPTION OF THE DRAWINGS

In the drawings:

Preferred features of the present invention will now be described, by way of example only, with reference to the accompanying drawings, in which:

FIG. 1 represents a monitoring device;

FIG. 2 illustrates the device of FIG. 1 installed in a wind turbine tower;

FIG. 3 illustrates the device of FIG. 1 under loading;

FIG. 4 illustrates potential installation locations of the device of FIG. 1; and

FIG. 5 illustrates an embodiment of a measuring means used in the device of FIG. 1.

### DETAILED DESCRIPTION OF THE PRESENTLY PREFERRED EMBODIMENTS

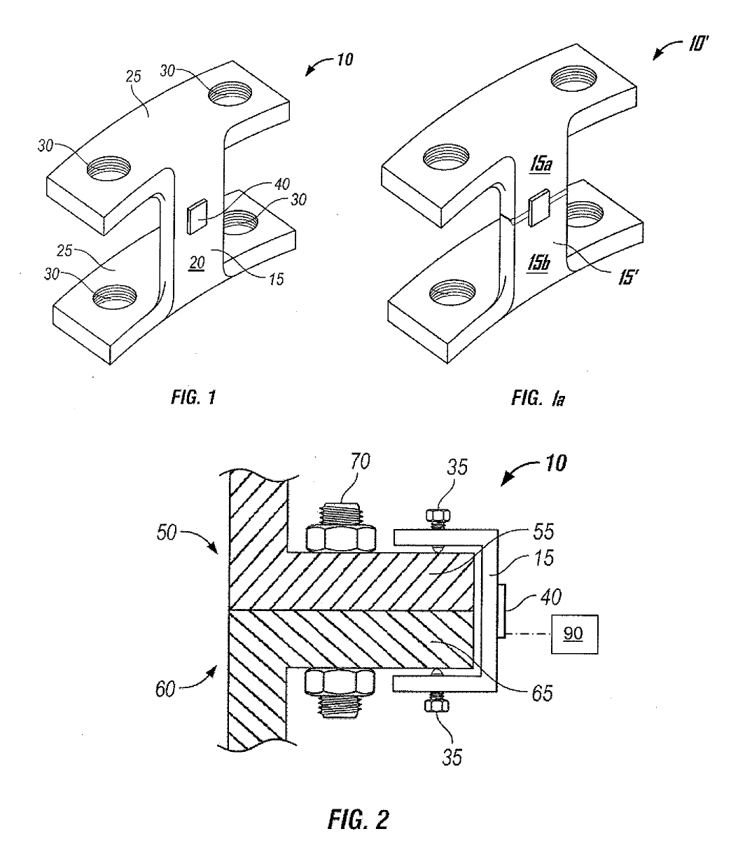

FIG. 1 illustrates a monitoring device 10 comprising a substantially two dimensional primary member 15 having a surface 20. At each end, the primary member 15 is connected to respective securing surfaces 25. Each securing surface 25 is arranged to lie substantially perpendicularly to the primary member 15. In this embodiment, each securing surface 25 comprises two tapped holes 30 for receiving a respective screw 35 (illustrated in FIG. 2) therein.

In this embodiment, the device 10 is formed from a deformable metallic material e.g. mild steel, carbon steel or iron alloy. In an alternative embodiment, as illustrated in FIG. 1a, the device 10′ is hinged 18 in a central region of the primary member 15′ such that two portions thereof 15a, 15b are provided. Relative displacement between the two portions 15a, 15b is detected by detection means 40.

Detection means 40 for detecting deformation (either elastic or plastic deformation) of the primary member 15 is provided in association with surface 20. In one embodiment, detection means 40 is provided by a strain gauge sensor that is bonded to the surface 20 of the primary member 15, however an optical sensor could replace the strain gauge. Alternatively, a contact switch, or a limit switch, may be used. The contacts for such a switch are installed in the device 10′ illustrated in FIG. 1a, whereby a first contact is connected to a first portion 15a of the primary member and a second contact is connected to a second portion 15b of the primary member. As these two portions 15a, 15b are separated contact is broken and the deformation of primary member 15′ is detected.

FIG. 2 illustrates part of a first section 50 of a wind turbine tower having a flange 55 formed thereon and part of a second section 60 of a wind turbine tower having a flange 65 formed thereon. The first and second sections 50, 60 of the wind turbine tower are joined to one another upon assembly of the wind turbine tower using a number of bolts 70, evenly distributed around a circumference of the tower.

The monitoring device 10 is placed over the interface of the flanges 55, 65 as illustrated, such that the primary member 15 is in line with a through thickness direction of the flanges. Screws 35 are tightened to secure the device 10 in place. In an alternative embodiment, the device 10 is secured directly to the flanges 55, 65 by bonding means or by magnetic means. In either embodiment the primary member 15 is secured in line with the through thickness direction of the flanges in a non-invasive way. By attaching the device 10 to the flanges 55, 65 without creating any damage thereto, the structural integrity of the tower 75 is unaffected thereby.

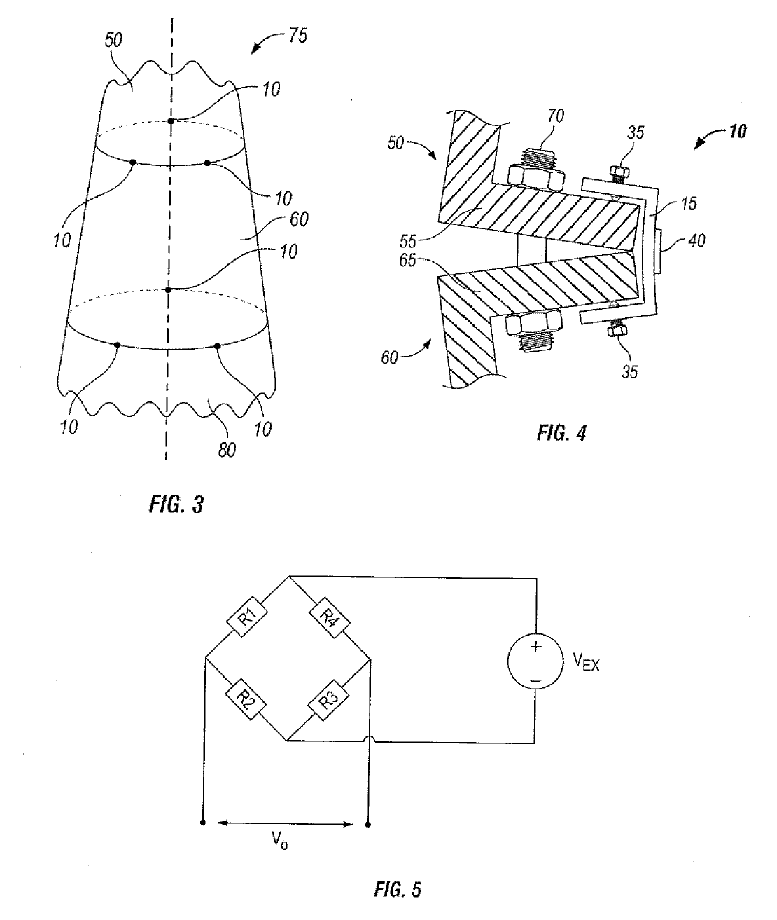

Three sections 50, 60, 80 of a wind turbine tower 75 are illustrated in FIG. 3. Each section 50, 60, 80 is substantially cylindrical. In this embodiment the cross-section is circular however, other cross-sections (e.g. rectangular or octagonal) may also be used. The tower 75 tapers slightly in a longitudinal direction such that each section is effectively frusto-conical in configuration. In this embodiment, three monitoring devices 10 are located at the interface between respective sections however, more or fewer devices 10 may be installed as deemed appropriate. Preferably, as shown, the locations of the monitoring devices 10 are distributed at approximately equidistant intervals around the circumference of the wind turbine tower 75.

A nacelle is generally mounted atop the wind turbine tower 75. One or more turbine blades (not shown) are connected to the nacelle and are configured to rotate about a central longitudinal axis thereof. The central longitudinal axis of the nacelle is typically substantially perpendicular to a longitudinal axis of the wind turbine tower 75.

In operation of the wind turbine, the turbine blades rotate about the axis of rotation. As the mass of the turbine blades is translated about the central axis, a shift in loading causes a fluctuating load to be exerted on the wind turbine tower 75. Consequently, the first and second sections 50, 60 of the wind turbine tower 75 are exposed to alternating compressive and tensile loading. The flanges 55, 65, in a region local to each respective bolt 70, are fractionally displaced relative to one another (as illustrated in FIG. 4) so that a corresponding alternating compressive and tensile loading pattern is exerted on each bolt 70.

Such a dynamic loading pattern, over time, fatigues a bolt and creep (i.e. elongation of the material forming the bolt) will occur. Once this happens, the first and second sections 50, 60 of the wind turbine tower 75 are no longer so securely retained together and displacements experienced thereby are exacerbated. Such increased displacement, further increases the loading exerted on the flanges and the bolts 70 will further deteriorate.

However, with monitoring devices 10 in place preferably adjacent to a bolt 70, displacement of the flanges 55, 65 together with elongation or creep of the bolts 70 can be monitored. Any displacement of the flanges 55, 65 relative to one another is detected by detection means 40 mounted on or associated with the flanges 55, 65. The number of loading cycles and the magnitude of any relative displacement of the flanges can be monitored to establish a time dependent loading characteristic experienced by the bolts. Such accurate monitoring permits an appropriate service interval to be ascertained and replacements of bolts to be scheduled. As a result, the service interval can generally be increased as the traditional approach of using predetermined, conservative service intervals can be discarded.

Detection means 40 is provided in communication with a remotely located control means 90. The detection means 40 may be hard wired to the control means 90 or, alternatively, wireless communication may be used, wherein the detection means 40 comprises transmitting means. In particular, the transmitting means may comprise a radio-frequency identification (RFID) element. Control means 90 comprises analysis means and/or storage means and is configured to receive a signal from detection means 40. The signal is indicative of a parameter related to the loading exerted on the bolt 70 e.g. a strain experienced at surface 20 by primary member 15. Such signals are recorded over time by the control means 90 to establish the time dependent loading characteristic.

Furthermore, if any unpredictable bolt failure occurs, for example due to a fault within the material of the bolt 70, such erratic behaviour can also be detected and an alert can be raised by the control means 90. Such an alert may simply indicate that maintenance is to be carried out within a particular time period. Alternatively, automatic shut down of the wind turbine installation can be initiated to prevent catastrophic failure of further components which may, in turn, lead to collapse of the entire wind turbine tower 75. Consequently, safety of operation of the installation is enhanced.

FIG. 5 illustrates one embodiment of a means of detecting relative displacement of one flange 55 with respect to the other flange 65. Detection means 40 is provided by a strain gauge affixed to the primary member 15. The output of the strain gauge is supplied to a standard bridge arrangement as illustrated in FIG. 5. The ratio of the excitation voltage, V_{EX}, to the output voltage, Vₒ, gives an indication of the strain to which the strain gauge is exposed. From this ratio, the relative displacement of one flange 55 with respect to the other flange 65 can be determined.

In an alternative embodiment, a linear variable differential transformer (LVDT) unit can be used to detect the relative displacement between adjacent sections 50, 60 of the wind turbine tower 75. A base unit of the LVDT is connected to or associated with a first section 50 e.g. by being connected to part 15a of primary member 15′. An actuable member of the LVDT is connected to or associated with a second section 60 of the wind turbine tower 75 e.g. by being connected to part 15b of primary member 15′. Relative displacement between the two sections 50, 60 results in relative displacement between the base unit and the actuable member. Circuitry associated with the LVDT is similar to the bridge arrangement, in that the displacement is directly proportioned to the output voltage, Vₒ.

In summary, structural loading of a wind turbine tower is unpredictable due to the dynamic nature of turbine blade motion coupled with varying strength and speed of incident wind. Conventionally, a maintenance schedule of such a wind turbine tower is particularly demanding. However, the maintenance schedule could be more relaxed and, consequently, energy production can be enhanced, by actively monitoring the actual loading experienced locally by components (such as flanges and bolts) within the tower, hub or rotor blade. By improving the telemetry, a more detailed and accurate assessment of the status of the components, in particular the bolts 70, is achieved.

Furthermore, if a substantial failure such as creep (or even fracture) of a bolt 70 were to take place this could be detected rapidly and replacement of the damaged component could be effected. In the extreme, shut down of the wind turbine installation could be initiated.

The invention has been described with reference to specific examples and embodiments. However, it should be understood that the invention is not limited to the particular examples disclosed herein but may be designed and altered within the scope of the invention in accordance with the claims.

1. A wind turbine installation monitoring device, for detecting relative movement between two adjacent components of a wind turbine installation, the device comprising:
a deformable member;
securing means, configured to enable the device to be connectable to a wind turbine installation, in use, such that the deformable member is located across an interface between the adjacent components of the wind turbine installation; and
detection means configured to detect deformation of the deformable member and thereby to detect relative movement between the two components.

2. A device according to claim 1, wherein the adjacent components of the wind turbine installation are each provided with flanges and the device is configured to be located across an interface between two flanges and secured to respective flanges in order to detect relative movement between the flanges.

3. A device according to claim 1, wherein the components are sections of a wind turbine tower of the wind turbine installation.

4. A device according to claim 1, wherein the securing means is non-invasive such that the wind turbine tower, to which the device is connected in use is not required to be reconfigured upon installation thereof.

5. A device according to claim 1, wherein the securing means comprises one of the group of clamping means, magnetic means and bonding means.

6. A device according to claim 1, wherein the detection means comprises a sensor.

7. A device according to claim 6, wherein the sensor is one of the group of a strain gauge and an optical sensor.

8. A device according to claim 1, wherein the detection means comprises one of the group of a limit switch and a contact switch.

9. A device according to claim 1i wherein the detection means is connected to a surface of the deformable member.

10. A device according to claim 1, wherein the deformable member comprises a hinge.

11. A device according to claim 1, wherein the detection means comprises means for transmitting a signal, indicative of a parameter associated with the detected relative movement, to analysing or storage means.

12. A device according to claim 11, wherein the transmitting means comprises a radio frequency identification (RFID) element.

13. A device according to claim 1, comprising determining means for receiving a signal from the detection means and determining an extent of the relative movement.

14. A wind turbine tower monitoring device, for detecting relative movement between flanges of adjacent sections of the tower, the device comprising:
a deformable member;
securing means, configured to enable the device to be connectable to a wind turbine tower, in use, such that the deformable member is located across an interface between adjacent flanges of the wind turbine tower; and
detection means configured to detect deformation of the deformable member and thereby to detect relative movement between the two flanges.

15. A wind turbine installation comprising:
a tower;
a hub mounted atop the tower; and
a rotor blade connected to the hub, wherein two adjacent components of the installation are connected to one another by a bolt, the installation comprising a device according to claim 1 located across an interface between the adjacent components to thereby detect relative movement between the two components.

16. A wind turbine tower comprising:
a first substantially cylindrical section;
a second substantially cylindrical section, configured to be assembled adjacent to the first section, each of the first and second sections having a flange formed thereon, the flanges being configured to be located adjacent one another upon assembly of the tower, the sections being secured to one another with one or more bolts each bolt being located through cooperating holes formed in each respective flange; and
a monitoring device, according to claim 1, located across an interface between the flanges and connected thereto enabling any relative movement between the flanges to be detected.

17. A tower according to claim 16, wherein the monitoring device is installed in proximity to a bolt.

18. A wind turbine installation comprising a tower according to claim 16.

19. A method for determining the status of a bolt installed between two components of a wind turbine installation, the method comprising the steps of:
monitoring load experienced by the bolt over time;
collating a time dependent loading characteristic for the bolt;
assessing a status of the bolt; and
raising an alarm if the assessing step indicates a failure of the bolt.

20. A method according to claim 19, wherein the assessing step determines a current status of the bolt.

21. A method according to claim 19, wherein the assessing step determines a predicted future status of the bolt.

22. A method according to claim 19, wherein the monitoring step comprises the steps of:
detecting a parameter indicative of relative displacement of two flanges through which the bolt is connected; and
sending a signal indicative of the detected parameter to monitoring means.

23. A method according to claim 19, wherein the assessing step comprises comparing the loading characteristic to a threshold characteristic and an alarm is raised if the threshold characteristic is exceeded.
